(19) United States
(12) Patent Application Publication
(10) Pub. No.: US 2023/0393877 A1
(43) Pub. Date: Dec. 7, 2023

(54) APPARATUS WITH DYNAMIC ARBITRATION MECHANISM AND METHODS FOR OPERATING THE SAME

(71) Applicant: Micron Technology, Inc., Boise, ID (US)

(72) Inventor: John E. Maroney, Irvine, CA (US)

(21) Appl. No.: 17/937,358

(22) Filed: Sep. 30, 2022

Related U.S. Application Data
(60) Provisional application No. 63/347,917, filed on Jun. 1, 2022.

(51) Int. Cl. G06F 9/455; G06F 3/06

(52) U.S. Cl. CPC G06F 9/45558; G06F 3/0614; G06F 2009/45583; G06F 3/0664; G06F 3/0688; G06F 3/0659

(57) ABSTRACT

Methods, apparatuses and systems related to dynamically controlling flow and implementation of operations for each function. The apparatus may use a timing parameter to initiate implementation of queued commands. The apparatus may include a queue arbiter configured to dynamically adjust the timing for each function according to a feedback that corresponds to resources consumed in implementing preceding commands for the corresponding function.

### CROSS-REFERENCE TO RELATED APPLICATION(S)

This application claims benefit of U.S. Provisional Application No. 63/347,917, filed Jun. 1, 2022; which is incorporated herein by reference in its entirety.

### TECHNICAL FIELD

The disclosed embodiments relate to devices, and, in particular, to semiconductor memory devices with read level management and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. Continuing advancements in computing technologies and communications technologies provide ever-increasing demands for faster, smaller, and reliable memory devices. However, these demands often counteract each other. For example, designs for faster and smaller devices often decrease reliability and/or performance predictability.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2A is a block diagram of a first example application of the computing system of FIG. 1 in accordance with an embodiment of the present technology.

FIG. 2B is a block diagram of a second example application of the computing system of FIG. 1 in accordance with an embodiment of the present technology.

FIG. 3 is a functional block diagram of the computing system in accordance with an embodiment of the present technology.

FIG. 4 is a flow diagram illustrating an example method of operating an apparatus in accordance with an embodiment of the present technology.

FIG. 5 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for managing quality of service (QoS). A computing system, such as an enterprise computer, a server, a distributed computing system, or the like, may include a memory system/device (e.g., a solid-state drive (SSD)) configured to store and provide access to data. The memory system may include a performance control mechanism configured to control the QoS performance by controlling information input-output (IO) rate (e.g., IO per second (IOPS)), bandwidth (BW), data placement location, or the like using a feedback mechanism.

In some applications, such as for data centers, the memory system can be configured to virtualize storage in multi-virtual machine (VM)/hypervisor environments provided by the operating system (OS) to partition the storage system into smaller portions. While the virtualized and partitioned environment may provide a more efficient use of BW/IOPS and storage capabilities, the memory system must contend with various challenges. Such challenges may be caused by die cost reductions, increasing communication rates, hypervisor overhead/latency, limited power footprint, or the like. As a result, conventional systems are unable to maintain a per-VM QoS for IOPS and BW performance.

As described in detail below, embodiments of the present technology leverage the performance control mechanism to provide the per-VM QoS control and the corresponding consistency and predictability in performance for each VM or partitioned environment. The memory system can leverage a hardware QoS per function feedback control to manage BW and TOPS flows from each VM to a backend storage portion. Accordingly, the memory system can allow each VM to get a portion of the overall system performance/capacity and prevent one VM from consuming an overwhelming amount of the system resources (e.g., the noisy neighbor problem).

In some embodiments, the performance control mechanism can include a machine-learning model or another pattern-recognition mechanism to classify traffic (e.g., the IO) based on feedback provided by placement or storage/access characteristics associated with the data. The performance control mechanism may further include an arbiter that is configured to control a queue via a weighted flow control or QoS scheduling. The performance control mechanism can include a placement engine that allocates queues, interrupts namespaces, and/or QoS control resources to functions using a virtualization management application.

### Example Environment

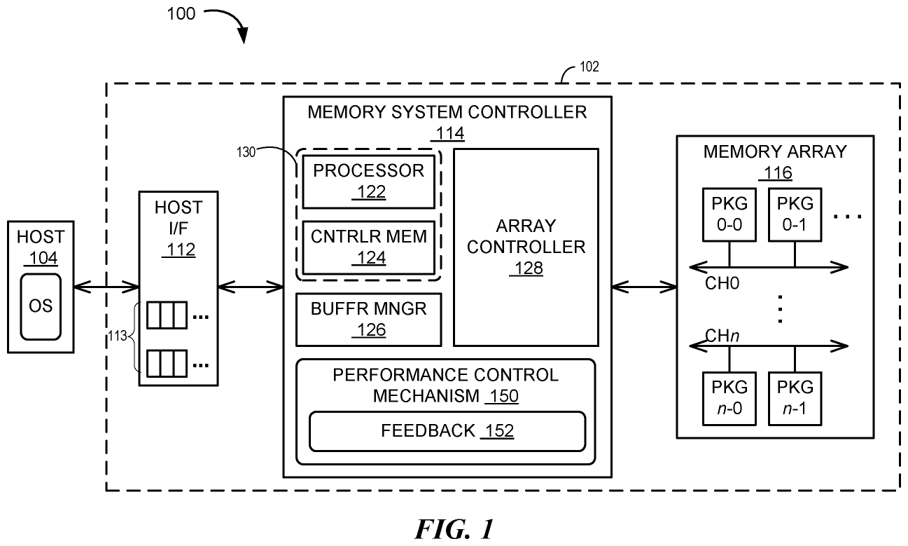

FIG. 1 is a block diagram of a computing system 100 in accordance with an embodiment of the present technology. The computing system 100 can include a personal computing device/system, an enterprise system, a mobile device, a server system, a database system, a distributed computing system, or the like. The computing system 100 can include a memory system 102 coupled to a host device 104. The host device 104 can include one or more processors that can write data to and/or read data from the memory system 102, such as during execution of an operating system. For example, the host device 104 can include an upstream central processing unit (CPU).

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, a Solid-State Drive (SSD) system, a SD card, or the like. In some embodiments, the memory system 102 can include a host interface 112 (e.g., buffers 113, transmitters, receivers, and/or the like) configured to facilitate communications with the host device 104. For example, the Host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104.

The memory system 102 can further include a memory system controller 114 and a memory array 116. The memory array 116 can include memory cells that are configured to store a unit of information. The memory system controller 114 can be configured to control the overall operation of the memory system 102, including the operations of the memory array 116.

In some embodiments, the memory array 116 can include a set of NAND Flash devices, chips, or packages organized according to a set of channels. Each of the packages can include a set of memory cells that each store data in a charge storage structure. The memory cells can include, for example, floating gate, charge trap, phase change, ferroelectric, magnetoresitive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate a threshold voltage (Vt) of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 2³) data states to store three bits of data, and quad level cells (QLCs) may be programmed to one of 16 (i.e., 2⁴) data states to store four bits of data.

Such memory cells may be arranged in rows (e.g., each corresponding to a word line 143) and columns (e.g., each corresponding to a bit line). The arrangements can further correspond to different groupings for the memory cells. For example, each word line can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

While the memory array 116 is described with respect to the memory cells, it is understood that the memory array 116 can include other components (not shown). For example, the memory array 116 can also include other circuit components, such as multiplexers, decoders, buffers, read/write drivers, address registers, data out/data in registers, etc., for accessing and/or programming (e.g., writing) the data and for other functionalities.

As described above, the memory system controller 114 can be configured to control the operations of the memory array 116. The memory system controller 114 can include a processor 122, such as a microcontroller, special purpose logic circuitry (e.g., a field programmable gate array (FPGA), an application specific integrated circuit (ASIC), etc.), or other suitable processor. The processor 122 can execute instructions encoded in hardware, firmware, and/or software (e.g., instructions stored in controller embedded memory 124 to execute various processes, logic flows, and routines for controlling operation of the memory system 102 and/or the memory array 116.

In some embodiments, the memory system controller 114 can include a buffer manager 126 configured to control and/or oversee information exchanged with the host device 104. The buffer manager 126 can interact with the host interface 112 regarding operations of receiving and/or transmitting buffers (e.g., buffers 113) therein.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In controlling the operations of the memory system 102, the memory system controller 114 (via, e.g., the processor 122 and the embedded memory 124) can implement a Flash Translation Layer (FTL) 130. The FTL 130 can include a set of functions or operations that provide translations for the memory array 116 (e.g., the Flash devices therein). For example, the FTL 130 can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL 130 can include a garbage collection function that extracts useful data from partially filed units (e.g., memory blocks) and combines them to a smaller set of memory units. The FTL 130 can include other functions, such as wear-leveling, bad block management, concurrency (e.g., handling concurrent events), page allocation, error correction code (e.g., error recovery), or the like.

In some embodiments, the computing system 100 may correspond to a data center application. For such embodiments, the computing system 100 can simultaneously support multiple virtual machines through the host 104 and the memory system 102. Accordingly, the memory system 102 can be configured to virtualize storage in multi-VM/hypervisor environments via corresponding partitions or portions in the memory array 116. To manage the operations of the multi-VM environments, the memory system 102 can include a performance control mechanism 150 that is configured to separately control performances of each VM/partition. As described in detail below, the performance control mechanism 150 can utilize feedback 152 to provide a per-VM QoS control and maintain the corresponding consistency and predictability in performance for each VM or partitioned environment. The performance control mechanism 150 can include hardware circuits, software, firmware, or a combination thereof. In some embodiments, the memory system 102 can implement the performance control mechanism 150 using the processor 122, the array controller 128, and/or the buffer manager 126. Additionally or alternatively, memory system 102 can implement the performance control mechanism 150 as a part of or in addition to the FTL 130.

### Computing System Architectures

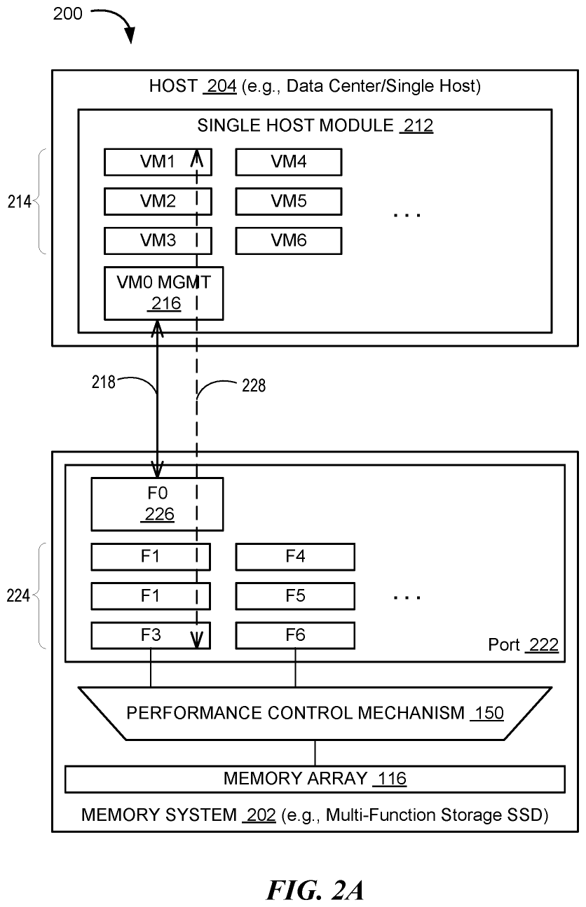

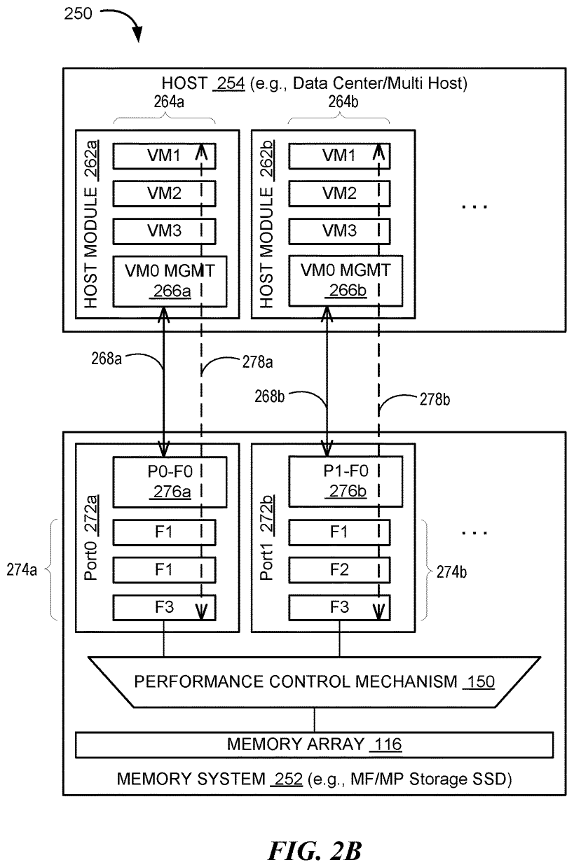

FIG. 2A is a block diagram of a first example architecture 200 (e.g., a first example scheme for the data center application) of the computing system 100 of FIG. 1 in accordance with an embodiment of the present technology. For the architecture 200, the computing system 100 can include a host 204 (e.g., an instance of the host 104 of FIG. 1 or a portion thereof) having a single host module/configuration 212 for host-side processors, OS, other circuits or SW, and/or the like. The host 204 can be configured to provide a multi-VM environment that can enable simultaneous processing or implementation of multiple VMs 214 (e.g., VM1, VM2, . . . , VMn) via a hypervisor/container OS. The host 204 can use a single physical layer (PHY) connection 218 to accommodate the interface with a memory system 202 (e.g., an instance of the memory system 102 of FIG. 1 having a single-port/multi-function configuration).

The memory system 202 can include or facilitate a single port 222 that corresponds to the PHY connection 218. The single port 222 can implement or facilitate multiple functions 224 that correspond to the multiple VMs 214. In some embodiments, the architecture 200 can correspond to a single host system, and the memory system 202 can correspond to a single unified multi-chip CPU system (e.g., corresponding to the configuration of the processor 122 of FIG. 1). Accordingly, the port 222 may correspond to a single host system PCIe root port. Each of the VMs 214 can be mapped one of the functions 224 through a VM management module 216 on the host-side and a base function 226 on the memory-side. The base function 226 can be for allocating queues, interrupts, namespaces, and/or QoS control resources to the functions 224 through a virtualization management application.

For such single host architecture, the memory system 202 can include the performance control mechanism 150 between the port 222 and the memory array 116. The performance control mechanism 150 can provision a customized memory size, storage size, BW, and/or TOPS for each VM-function mapping 228. Accordingly, the performance control mechanism 150 can control and manage the QoS for each of the VMs 214.

In other embodiments, the computing system 100 may be configured for a multi-host architecture, such as for automotive advanced driver assistance systems (ADASs). FIG. 2B is a block diagram of a second example architecture 250 (e.g., a second example scheme for the data center application) of the computing system 100 of FIG. 1 in accordance with an embodiment of the present technology. For the architecture 250, the computing system 100 can include a host 254 (e.g., an instance of the host 104 of FIG. 1 or a portion thereof) having a set of host modules 262 (e.g., modules 262a, 262b, etc.) for host-side processors, OS, other circuits or SW, and/or the like. Each of the host modules 262 can be configured to provide a multi-VM environment. In other words, host module 262a can provide an environment for implementing a corresponding set of VMs 264a, and host module 262b can provide an environment for or implementing a corresponding set of VMs 264b. The host 254 can include separate PHY connections 268 (e.g., 268a, 268b, etc.) to accommodate the interface with a memory system 252 (e.g., an instance of the memory system 102 of FIG. 1 having a multi-port/multi-function configuration).

As an illustrative example, the host modules 262 can include system on modules (SOMs) root ports. The host 254 can include one or more SOM clusters (e.g., two, four, or more SOMs per cluster) configured for application environment (e.g., ADAS). Each SOM can include one or more host processors and/or specialized logics (e.g., machine learning offload engine) to analyze input data and generate corresponding output signals. Each SOM can implement or run the corresponding set of VMs for the analysis, and the input/output signals can be communicated via a corresponding set of the PHY connections 268.

The memory system 252 can include or facilitate a set of ports 272 (e.g., 272a, 272b, etc.) that corresponds to the PHY connections 268. In some embodiments, the set of ports 272 can correspond to SOM root ports, and the memory system 252 can be implemented without a multi-root switch. The set of ports 272 can correspond to circuitry configured to implement or facilitate multiple functions 274 (e.g., 274a, 274b, etc.) that correspond to multiple VMs 264. In some embodiments, the architecture 250 can correspond to a multi-host system, and the memory system 252 can correspond to a multi-chip CPU system (e.g., corresponding to the configuration of the processor 122 of FIG. 1). Each grouping of the VMs 264 can be mapped a grouping of the functions 274 per the module-port pairing. Additionally, each of the VMs 264 can be mapped to one of the functions 274 one of the functions 224 through a VM management module 266 (e.g., 266a, 266b, etc.) on the host-side and a base function 276 (e.g., 276a, 276b, etc.) on the memory-side. The base function 276 for each port can be configured for allocating queues, interrupts, namespaces, and/or QoS control resources to the corresponding set of functions 274 through a virtualization management application.

For such multi-host architecture, the memory system 252 can include the performance control mechanism 150 between the ports 272 and the memory array 116. The performance control mechanism 150 can provision a customized memory size, storage size, BW, and/or TOPS for each module-port mapping and/or each VM-function mapping 278 (e.g., 278a, 278b, etc.). Accordingly, the performance control mechanism 150 can control and manage the QoS for each of the VMs 264.

### VM/Function Specific Performance Control Architecture

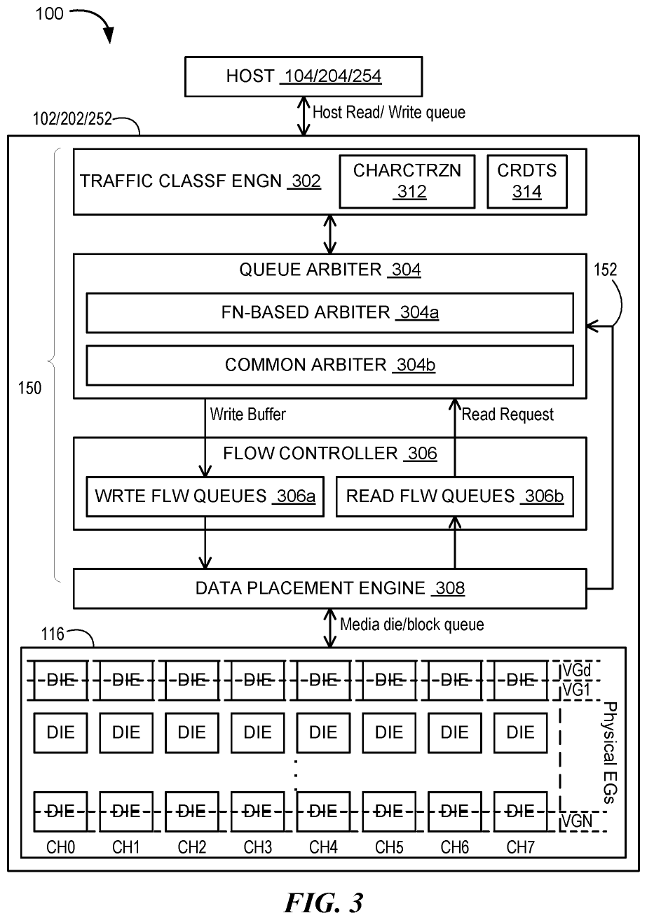

FIG. 3 is a functional block diagram of the computing system 100 in accordance with an embodiment of the present technology. The computing system 100 can include a host (e.g., the host 104) having a single-host configuration or a multi-host configuration (e.g., the host 204 or 254) coupled to the memory system 102 having a corresponding single-port or multi-port configuration (e.g., the memory system 202 or 252). During operation, the host 104 can provide read and/or write commands to the memory system 102. The commands can be queued at the memory system 102 (at e.g., the host interface 112 of FIG. 1) and processed via the memory system controller 114 of FIG. 1 and the memory array 116 of FIG. 1. In processing the commands, the memory system 102 can use the performance control mechanism 150 to manage the resource allocation to each function and the corresponding VM, thereby managing and controlling the QoS measure for each VM.

The performance control mechanism 150 can include a traffic classification engine 302. The traffic classification engine 302 can be configured to characterize or predict a context associated with each incoming or queued command. The traffic classification engine 302 can determine a characterization 312 that represents an estimated behavior, context, or usage pattern for the incoming or queued command. In other words, the traffic classification engine 302 can tag each transfer with the characterization 312 that effectively represents a priority that corresponds to the participating VM. Additionally or alternatively, the characterization 312 can include other contextual data, such as a time stamp.

The traffic classification engine 302 can analyze the queues/streams of commands and/or data from the host 104 to classify or categorize data traffic access patterns and/or transfer types (e.g., sequential or random, classification according to block size, or the like). For example, the traffic classification engine 302 can determine the characterization 312 that relatively prioritizes in the order of (1) random accesses with relatively small block sizes (e.g., as defined by one or more block size thresholds), (2) random accesses with relatively larger block sizes, and (3) sequential accesses prioritizing smaller block sizes over larger block sizes.

As an illustrative example, the traffic classification engine 302 can access or review the host input traffic queued (via, e.g., read/write buffers 113) in the host interface 112. In some embodiments, the performance control mechanism 150 can store and leverage history data regarding command and usage patterns (e.g., previous time stamps, command sequences, etc.) to characterize and/or predict the context associated with each command and a corresponding subsequent command(s) or predicted demand. The traffic classification engine 302 can compare the queued commands and/or the historical data to previous behaviors (as, e.g., represented in the trained model) to determine the characterization 312 for each queued command.

The traffic classification engine 302 can issue credits 314 to each type of transfer within each function (e.g., representative of a fraction of all functions in the device). The transfer credits 314 can represent the data transfer amounts or durations allotted to the functions. In some embodiments, the traffic classification engine 302 can calculate the credits 314 based on dividing a transfer length by a sampling time (e.g., a common sampling time across function-specific arbitration). As an illustrative example, the memory system 102 can be a 3.84 TB drive with 1M TOPS, 4 KB random read TOPS, and 6600 MB/s BW capabilities for 32 functions. When the host for such system sets a max TOPS of 31250 and/or a BW limit per function of 206 MB/s, the credit 314 can correspond to 6.4 us (e.g., (3*time=BW−credits, 5*time=IOPS−credits)/# queues per function) based on a 4 KB block size. Accordingly, the traffic classification engine 302 can satisfy queue sampling targets (e.g., the number queues to sample) and the BW and/or the IOPs performance limits as determined by a policy for the corresponding function. The policy (e.g., a host policy) can be an overarching description of the BW for data transfers associated with the corresponding function. The host 104 can provide the policy to establish a targeted behavior/BW for the memory system 102.

In some embodiments, the traffic classification engine 302 can use a pattern recognition mechanism (e.g., a machine-learning model, such as a feedforward neural network and/or an adaptive learning model) to characterize or predict the context, determine the characterization 312, issue the credits, 314, or the like. Additionally or alternatively, the traffic classification engine 302 can use hardware configurations, software instructions, and/or firmware to characterize or predict the context, determine the characterization 312, issue the credits, 314, or the like using parameters, thresholds, and/or patterns specified by a manufacturer or a designer.

The traffic classification engine 302 can pass the command along with the corresponding characterization 312 and/or the credit 314 to a queue arbiter 304 for further processing. The queue arbiter 304 can use the characterization 312 to control an implementation timing or a relative sequence. Effectively, the queue arbiter 304 can select which command gets implemented first and effectively reorder the queued commands to a new sequence different than a received sequence of the same commands. The queue arbiter 304 can facilitate a weighted flow control according to the characterization 312. For example, the queue arbiter 304 can assign higher weights or priorities for read operations in comparison to write operations, small or random traffic over large sequential transfer, and/or the like.

As an illustrative example, the queue arbiter 304 can include a function-based arbiter 304a that samples the queues (e.g., the buffers 113 in the host interface 112 and/or the buffer manager 126 of FIG. 1) per function (e.g., the functions 224 of FIG. 2A and/or the functions 274 of FIG. 2B). The function-based arbiter 304a can track (via, counting down) the credits 314 for each function based on the sampling results. When the credit 314 for a function reaches a threshold (e.g., when the credit 314 counts down to zero), the function-based arbiter 304a can trigger a release of a command in the queue into a common arbiter 304b shared across the functions (e.g., all of the functions and/or across one or more subsets thereof). The common arbiter 304b may arbitrate the commands randomly or according to a predetermined order/hierarchy (e.g., a round-robin format). The function-based arbiter 304a and/or the common arbiter 304b can operate and oversample according to a relatively high frequency (e.g., higher than a maximum command frequency or a processing rate thereof) thereby minimizing or removing any latency added by the arbiters.

The queue arbiter 304 can dynamically adjust the credit 314 assigned to each function. The rate allocation for the for write BW and/or IOPS for each function can be dynamically adjusted by adjusting the credit 314 based on the feedback 152 (e.g., data storage locations, access statistics, resource demand/usage per function/VM, or the like) associated with the preceding data placement for the function. For example, the queue arbiter 304 can dynamically reduce the credit 314 (e.g., the counter value) for functions having resource consumptions (as indicated by the feedback 152) above a maximum threshold and/or having the characterization 312 or priority lower than the resource consumption rate. The queue arbiter 304 can increase the credit 314 when the priority increases and/or when the consumption rate decreases relative to one or more thresholds. The thresholds and the patterns for controlling the credit 314 can be determined according to the policy.

In some embodiments, the queue arbiter 304 can be implemented as a hardware circuit (e.g., logic). In other words, the queue arbiter 304 can include circuitry, such as a state machine, that is configured (e.g., without or with minimal software instructions) to control the implementation timing or the relative sequence of the commands and data.

The queue arbiter 304 (via, e.g., the common arbiter 304b) can release the queued information (e.g., commands) to a flow controller 306. The flow controller 306 can be implemented using the processor 122, the FTL 130, and/or the array controller 128 to control the overall communication or a flow of commands/information between the memory system controller 114 and the memory array 116. In some embodiments, the flow controller 306 can includes a write buffer and/or a read buffer for controlling the flow according to read and write commands. The read buffer can be configured for mixed RND/SEQ reads and block sizes in one direction (e.g., from the memory array 116), the write buffer can be configured for mixed RND/SEQ writes and block sizes in a different direction (e.g., to the memory array 116). The information from the queue arbiter 304 may be queued in the write buffer, and the data read from storage can be queued in the read buffer. The information (e.g., data transfer chunk) queued in the read and write buffers can have the associated characterization 312 (e.g., a classification, a priority, a timestamp, etc.).

The performance control mechanism 150 can further include a data placement engine 308 (e.g., the processor 122, the array controller 128, the FTL, 130, or a combination thereof) configured to schedule memory operations (e.g., reads and writes) according to the characterization 312. The data placement engine 308 can schedule the memory operations according to the context of the corresponding functions by applying the characterization 312 to the read/write transfers according to the QoS policy. For example, the data placement engine 308 can schedule the read and/or write transfers according to the priority associated with the corresponding characterization 312 and according to the QoS policy. The data placement engine 308 can schedule the reads/writes according to the priority, thereby managing or throttling read IOPS/BW or write IOPS/BW to support the Qos policy. The data placement engine 308 can implement the transfer and perform the corresponding data placement. Accordingly, the data placement engine 308 can provide the memory array 116 with the queued information associated with the read/write operations. The data placement engine 308 can control the placement of the data according to the source/name space. In other words, the data placement engine 308 can group the physical storage of the data associated with the same source or name space. The data placement engine 308 can group according to blocks, packages, channels, and/or data stripes to limit fragmentations and/or increase access times.

In some embodiments, the data placement engine 308 can perform the data placement according to a write block caching or moving read window mechanism. In using such mechanism, the data placement engine 308 can cache or suspend in-flight blocks (via, e.g., program/erase suspension function) to temporarily inhibit writes within a moving read window on a data stripe or a majority segment thereof. The data placement engine 308 can utilize a write flush window for a smaller portion of the stripe according to the write BW limit to maintain the QoS policies.

Alternatively or additionally, the data placement engine 308 can perform the data placement according to a RAID block parity regeneration mechanism. For such mechanism, the data placement engine 308 can use the RAIN parity overhead as the write window combined with the suspension function to temporarily inhibit writes within the moving read window on a data stripe or a majority segment thereof. The data placement engine 308 can regenerate the reads from parity outside of the write window. The data placement engine 308 can utilize a write flush window for a smaller portion of the stripe according to the write BW limit to maintain the QoS policies.

In some embodiments, the memory system 102 can organize the memory blocks or portions of memory dies into virtual endurance groups (VGs). The performance control mechanism 150 can control the data for each function to flow to one or more corresponding virtual endurance groups (VGs) (e.g., groupings of memory blocks, memory dies, or portions thereof). When the number of functions are low (e.g., below a predetermined floor), the VGs can correspond to physical endurance groups (EGs) (e.g., dies or other physical circuit groupings, such as controller channels). When the number of functions is relatively high (e.g., above a predetermined ceiling), the memory system 102 can organize or overlay a greater number of VGs on the physical EGs.

The data placement engine 308 can generate the feedback 152 for performing rate control per queue. The feedback 152 can effectively represent the amount of traffic or resource consumption associated with a specific queue, function, and/or the host VM. For example, the data placement engine 308 can track the amount of data written and/or read by each function over time. In some embodiments, the data placement engine 308 can generate the feedback 152 including the tracked data size over time, and the queue arbiter 304 can compare the feedback 152 to corresponding threshold limits associated with the policy. In other embodiments, the data placement engine 308 can perform the comparison of the tracked rates to the corresponding policy limits and generate the feedback 152 as a resulting indication to increase or decrease the credit for the analyzed function.

Regardless of the single ported architecture (e.g., the first architecture 200 of FIG. 2A) or the multi-ported architecture (e.g., the second architecture 250 of FIG. 2B), the memory system 102 including the traffic classification engine 302, the queue arbiter 304, the flow controller 306, and/or the data placement engine 308 can provide increased reliability and efficiency for managing QoS BW and TOPS. In other words, the memory system 102 can leverage the characterization 312, the credit 314, and/or the feedback 152 to provide function-specific BW or TOPS control and reduce/prevent noisy neighbor issues.

### Control Flow

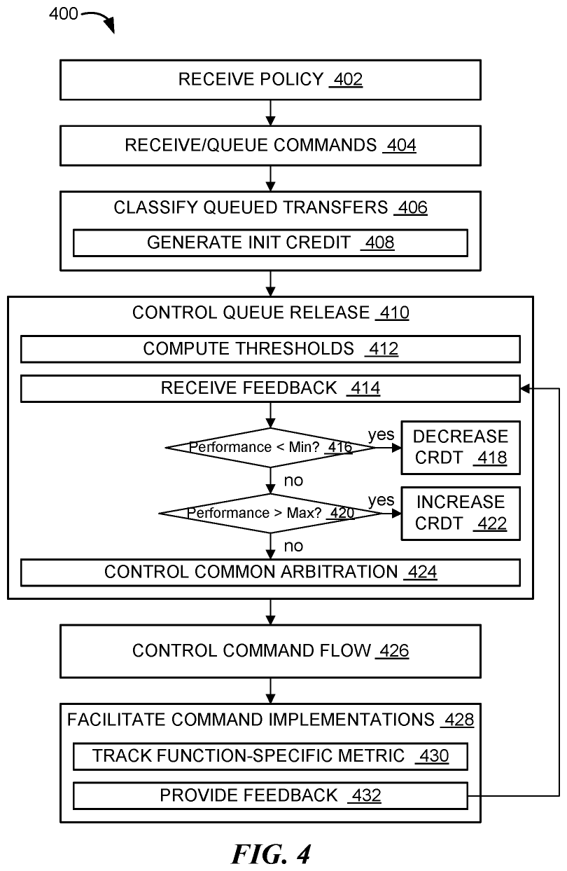

FIG. 4 is a flow diagram illustrating an example method 400 of operating an apparatus (e.g., the computing system 100, the memory system 102, and/or the memory system controller 114, all illustrated in FIG. 1) in accordance with an embodiment of the present technology. The method 400 can be for implementing function-specific rate or flow controls using feedback in a multi-function environment.

At block 402, the apparatus can receive one or more policies that correspond to a set of VM-function pairings. The host 104 of FIG. 1 can provide the policies describing a targeted performance or a required performance for each VM 214/264 at the host 104 and the corresponding function 224/274 at the memory system 102. The memory system 102 can use the provided policies as guides for controlling implementation rates or flow rates for commands associated the functions. Accordingly, the memory system 102 can use the policy to perform the per-function QoS control.

At block 404, the apparatus can receive and queue (via, e.g., the buffers 113 of FIG. 1) the commands and/or data (e.g., write data) provided by the host 104. The provided commands and/or data can be issued by the VMs. Accordingly, the memory system 102 can deploy the functions to implement the commands and/or process the data associated with the corresponding VMs.

At block 406, the apparatus can classify the queued transfers/commands. For example, the memory system 102 can use the traffic classification engine 302 of FIG. 3 to analyze the received commands. In classifying the commands, the memory system 102 can use various factors, such as whether each command is a read command or a write command, identify the function associated with each command, determine a pattern in the time stamps across a recent set of commands for the function, determine a data/block size associated with the command, determine a pattern in the block sizes across a resent set of commands for the function, or a combination thereof. The traffic classification engine 302 can determine the characterization 312 of FIG. 3 of the command as a result of the classification analysis.

At block 408, the apparatus can generate an initial credit for each function. For example, the memory system 102 can use the traffic classification engine 302 to generate the initial value of the credit 314 for each command. In some embodiments, the initial credit 314 can correspond to an initial/default value for a count-down timer or a threshold for an up-counter that controls a release timing for the corresponding command. The memory system 102 can compute the initial value for the credit 314 based on using one or more characteristics (e.g., read/write, the function, the time-based pattern, etc.) of the queued command, the characterization 312, the function policy, or a combination thereof as inputs into a predetermined process/equation, a lookup table, a trained model, or the like.

At block 410, the apparatus can control queue release/arbitration. For example, the memory system 102 can use the queue arbiter 304 of FIG. 3 to initiate flow of commands from the queue to downstream circuits for implementation. The memory system 102 can use the function-based arbiter 304a of FIG. 3 to initiate the flow of commands for each function. Subsequently, the memory system 102 can use the common arbiter 304b of FIG. 3 to control the flow of the commands across multiple functions.

For an initial set of commands, the function-based arbiter 304a can release the commands based on the initial value of the credit 314. As an illustrative example, the function-based arbiter 304a can receive and identify the next command for each function and the corresponding credit 314. The function-based arbiter 304a can incrementally update the timer and release the next command according to the credit 314 when the timer reaches an end. In some embodiments, for example, the function-based arbiter 304a can use the credit 314 as an initial value of a count-down timer and release the next command for the corresponding function from the queue when the timer reaches 0.

At block 412, the apparatus can compute one or more implementation thresholds (e.g., consumption thresholds) associated with each function. For example, the queue arbiter 304 and/or the data placement engine 308 of FIG. 3 can analyze the host policy, the characterization 312, and/or the like for each identified function and command to compute a set of thresholds. In some embodiments, the memory system 102 can determine a minimum performance threshold (e.g., a minimum and a maximum resource/BW consumption thresholds) according to the host policy and the characterization 312.

At block 414, the apparatus can receive the feedback (e.g., the feedback 152 of FIG. 1) from the data placement engine 308. In other words, the queue arbiter 304 can receive actual real-time performance measurements (e.g., resource/BW consumption measurements) for each function as tracked by the data placement engine 308. Accordingly, the queue arbiter 304 can identify the actual consumptions associated with executions of preceding/initial set of commands for each function. The queue arbiter 304 can control the release timing for each of the commands by comparing the feedback to the host policy or the corresponding thresholds. Based on the comparisons, the queue arbiter 304 can adjust (e.g., increase or decrease) or maintain the credit 314.

For example, at decision block 416, the apparatus can determine whether the real-time performance associated with the function is below a minimum threshold. In other words, the function-based arbiter 304a can use the minimum threshold to identify under-utilized or overly restricted functions as represented by the feedback 152. For such functions performing below the minimum threshold, the function-based arbiter 304a can adjust the command release timing by decreasing the credit 314 as illustrated at block 418. In other words, the function-based arbiter 304a can decrease the period or the delay between releases for the commands in the underperforming function. Accordingly, the function-based arbiter 304a can increase the command throughput for subsequent commands in the underperforming function.

For other functions that are performing above the minimum threshold, the apparatus can determine whether the real-time performance associated with the function is above a maximum threshold as illustrated at decision block 424. In other words, the function-based arbiter 304a can use the maximum threshold to identify over-utilized or greedy functions as represented by the feedback 152. For such greedy functions, the function-based arbiter 304a can adjust the command release timing by increasing the credit as illustrated at block 422. In other words, the function-based arbiter 304a increase the period or the delay between releases for the commands in the greedy function. Accordingly, the function-based arbiter 304a can reduce the command throughput for subsequent commands in the greedy function.

In some embodiments, the function-based arbiter 304a can adjust the credit 314 according to one or more traits associated with the upcoming command. For example, the function-based arbiter 304a can be configured to prioritize (1) read operations over write operations, (2) random transfers over sequential transfers (e.g., as characterized by transfer sizes and/or received timings for the queued commands), and/or (3) transfers with smaller block sizes over transfers with larger block sizes (e.g., as defined by one or more block size thresholds).

For functions that are performing within the minimum and maximum thresholds (e.g., within the policy range), the function-based arbiter 304a can maintain the credit 314. The function-based arbiter 304a can receive the feedback 152 and/or adjust the function-specific performances according to a sampling period and/or for every n number of commands.

At block 424, the apparatus can control common arbitration. For example, the common arbiter 304b) can receive the released commands from the function-based arbiter 304a and arbitrate the implementation of the commands across the different functions. The function-based arbiter 304a can allow the commands to propagate downstream according to a predetermined sequence (e.g., round-robin hierarchy) of the functions.

At block 426, the apparatus can control the command flow. For example, the flow controller 306 of FIG. 3 can separate and queue the commands according to reads or writes as described above.

At block 428, the apparatus can facilitate the command implementation. For example, the data placement engine 308 can provide an interface with the memory array 116 of FIG. 1 for implementing the queued/released commands. The data placement engine 308 can track the performance metric (e.g., the consumption measure) for each function while facilitating the command implementation as illustrated in block 430. At block 432, the data placement engine 308 can provide the tracked metric as the feedback 152 to the queue arbiter.

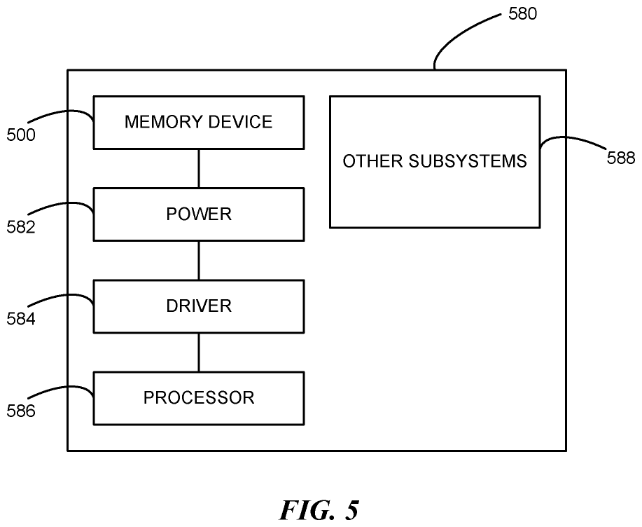

FIG. 5 is a schematic view of a system that includes an apparatus in accordance with embodiments of the present technology. Any one of the foregoing apparatuses (e.g., memory devices) described above with reference to FIGS. 2A-5 can be incorporated into any of a myriad of larger and/or more complex systems, a representative example of which is system 580 shown schematically in FIG. 5. The system 580 can include a memory device 500, a power source 582, a driver 584, a processor 586, and/or other subsystems or components 588. The memory device 500 can include features generally similar to those of the apparatus described above with reference to one or more of the FIGS, and can therefore include various features for performing a direct read request from a host device. The resulting system 580 can perform any of a wide variety of functions, such as memory storage, data processing, and/or other suitable functions. Accordingly, representative systems 580 can include, without limitation, hand-held devices (e.g., mobile phones, tablets, digital readers, and digital audio players), computers, vehicles, appliances and other products. Components of the system 580 may be housed in a single unit or distributed over multiple, interconnected units (e.g., through a communications network). The components of the system 580 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media, magnetic storage media, phase-change storage media, ferroelectric storage media, dynamic random access memory (DRAM) devices, etc.

The term “processing” as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term “dynamic” as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

I/We claim:

1. A memory device, comprising:
a set of buffers for receiving commands and/or data from a host, wherein the set of buffers are configured to queue the commands and/or data associated with multiple virtual machines (VMs) implemented by the host with each VM corresponding to a function implemented at the memory device to write the data and/or provide previously stored read data; and
a queue arbiter configured to control flows or execution timings of the commands according to corresponding functions, wherein controlling the flows or execution timings include—
identifying one or more functions associated with the queued commands;
determining a host policy for each of the identified functions, wherein the host policy describes one or more targeted bandwidths (BWs) for the corresponding function;
receiving a feedback for each function, wherein the feedback represents a resource consumption measurement associated with executions of preceding commands for the corresponding function; and
controlling a release timing for releasing each of the commands from the set of buffers for backend storage and/or access operations, wherein the release timing is controlled per each function by comparing the corresponding host policy and the corresponding feedback.

2. The memory device of claim 1, wherein the queue arbiter is configured to control the flows or execution timings based on:
identifying an initial credit for each function, wherein the initial credit represents an initial value for the release timing as estimated or classified according to characteristics of received commands associated with the corresponding function;
controlling the release timing includes—
increasing or decreasing the initial credit according to the feedback;
incrementally updating a timer according to the increased or decreased credit; and
releasing each of the queued commands for implementation when the timer reaches an end.

3. The memory device of claim 2, further comprising a traffic classification engine configured to:
receive policies associated with the queued commands; and
generate the initial credit for each of the queued commands according to one or more characteristics of the queued commands and/or the policies, wherein the initial credit is a default value for the release timing according to the characteristics of the incoming commands and without adjusting for actual backend data flows for the corresponding function.

4. The memory device of claim 3, wherein the queue arbiter is configured to adjust the initial credit according to one or more rules for prioritizing (1) read operations over write operations, (2) random transfers over sequential transfers, wherein the random and sequential transfers are distinguished according to transfer sizes and/or received timings for the queued commands, and/or (3) transfers with smaller block sizes over transfers with larger block sizes as defined according to one or more block size thresholds.

5. The memory device of claim 4, wherein the queue arbiter is configured to increase or decrease the initial credit according to one or more comparisons between the resource consumption measurement and one or more thresholds associated with the one or more prioritization rules.

6. The memory device of claim 1, further comprising:
a data placement engine coupled downstream from the queue arbiter and configured to provide an interface with a memory array for implementing the queued commands, wherein the data placement engine generates the feedback based on actual implementation of preceding commands associated with the function represented by the feedback.

7. The memory device of claim 6, further comprising:
a traffic classification engine coupled to and between the set of buffers and the queue arbiter and configured to classify the queued commands and generate the initial credits accordingly, wherein
the queue arbiter is implemented as a hardware state machine that is configured to control the release timing for passing the queued commands to the data placement engine for implementation.

8. The memory device of claim 1, wherein:
the memory device has an architecture that includes a centralized port for implementing functions that correspond to VMs implemented by a centralized module at the host; and
the queue arbiter is configured to control quality of service (QoS) for implementing the functions associated with the centralized port.

9. The memory device of claim 1, wherein:
the memory device has an architecture that includes multiple ports each configured for implementing a set of functions, the architecture reflective of the host having multiple host modules each configured for implementing a set of VMs; and
the queue arbiter is configured to control quality of service (QoS) for implementing the functions associated with the multiple ports.

10. The memory device of claim 1, wherein the queue arbiter is configured to limit a resource consumption of the corresponding function according to the host policy for reducing or preventing the function from consuming an uneven majority of command implementation resources.

11. A method of operating a memory device configured to implement multiple functions that each correspond to a virtual machine (VM) implemented at a host, the method comprising:
using a set of buffers, receiving commands and/or data provided by multiple VMs at the host;
identifying the functions associated with the received commands;
implementing an initial portion of the commands for each function according to a timing value initially assigned to the corresponding function, wherein implementing the commands include writing data to a backend storage or reading data from the backend storage according to the timing value;
determining a feedback for each function based on implementing the initial portion of the commands, wherein the feedback represents an amount of resource consumed by the corresponding function; and
adjusting the timing value to a new value based on the feedback, wherein the timing value is independently adjusted for one or more or each of the functions for providing function-specific quality of service (QoS) control.

12. The method of claim 11, further comprising:
generating a classification for each of the queued commands according to the identified function, a command type, a timestamp, or a combination thereof;
determining the initial timing value based on the classification; and
wherein the timing value is subsequently adjusted according to a policy provided by the host for establishing an overall performance for the corresponding function.

13. The method of claim 11, wherein the timing value is adjusted based on prioritizing (1) read operations over write operations, (2) random transfers over sequential transfers, wherein the random and sequential transfers are distinguished according to transfer sizes and/or received timings for the queued commands, and/or (3) transfers with smaller block sizes over transfers with larger block sizes as defined according to one or more block size thresholds.

14. The method of claim 11, wherein the timing value is adjusted to limit a resource consumption of the corresponding function according to the host policy for reducing or preventing the function from consuming an uneven majority of command implementation resources.

15. The method of claim 11, wherein the timing value is adjusted using a hardware state machine.

16. A memory system, comprising:
a memory array configured to store write data and read stored data;
a set of buffers for receiving commands and/or data from a host, wherein at least a subset of the commands are for storing the write data and/or for reading the stored data, wherein the set of buffers are configured to queue the commands and/or data associated with multiple virtual machines (VMs) implemented by the host with each VM corresponding to a function implemented at the memory system;
a memory controller coupled to the memory array and configured to facilitate write and/or read operations, wherein the memory controller includes a hardware state machine configured to—
identify one or more functions associated with the queued commands;
determine a host policy for each of the identified functions, wherein the host policy describes one or more targeted bandwidths (BWs) for the corresponding function;
receive a feedback for each function, wherein the feedback represents a resource consumption measurement associated with executions of preceding commands for the corresponding function; and
control a release timing for releasing each of the queued commands from the set of buffers for implementing the corresponding write and/or read operations, wherein the release timing is controlled per each function by comparing the corresponding host policy and the corresponding feedback.

17. The memory system of claim 16, wherein the queue arbiter is configured to control the flows or execution timings based on:
identifying an initial credit for each function, wherein the initial credit represents an initial value for the release timing as estimated or classified according to characteristics of received commands associated with the corresponding function;
controlling the release timing includes—
increasing or decreasing the initial credit according to the feedback;
incrementing a timer according to the increased or decreased credit; and
releasing each of the queued commands for implementation when the incremented timer reaches an end.

18. The memory system of claim 16, further comprising:
a data placement engine coupled downstream from the queue arbiter and configured to provide an interface with the memory array for facilitating implementation of the queued commands, wherein the data placement engine generates the feedback based on actual implementation of preceding commands associated with the function represented by the feedback.

19. The memory system of claim 16, further comprising:
a traffic classification engine coupled to and between the set of buffers and the queue arbiter and configured to classify the queued commands and generate the initial credits accordingly, wherein
the queue arbiter is implemented as a hardware state machine that is configured to control the release timing for passing the queued commands to the data placement engine for implementation.

20. The memory system of claim 16, wherein the queue arbiter is configured to limit a resource consumption of the corresponding function according to the host policy for reducing or preventing the function from consuming an uneven majority of command implementation resources.
